(19) United States
(12) Patent Application Publication
(10) Pub. No.: US 2006/0288841 A1
(43) Pub. Date: Dec. 28, 2006

(54) Stringed musical instrument

(76) Inventor: Cosmos Lyles, Durham, NC (US)

Correspondence Address: DAVID P. HENDRICKS;LAW OFFICE OF DAVID P. HENDRICKS, PO BOX 37127, RALEIGH, NC, 27627, US

(21) Appl. No.: 11/159,958

(22) Filed: Jun. 23, 2005

(51) Int. Cl. G10D 3/06; G10D 3/04; G10D 1/08

(52) U.S. Cl. 84/314 R

(57) ABSTRACT

A stringed musical instrument is disclosed that allows the use of the portion of the strings on either side of the point where pressure is applied to the strings, such as at a fret, to produce musical tones. The stringed musical instrument may be of an electric or acoustic type. For the electric type, one or more electrical pickups are provided near the end of the strings that are secured to the body of the stringed musical instrument, and one or more additional electrical pickups are provided near the end of the strings that are attached to the head of the stringed musical instrument. For the acoustic type, a hole in the soundboard of the body of the stringed musical instrument is provided near the end of the strings that are secured to the body of the stringed musical instrument, and a hole in the soundboard is provided near the end of the strings that are attached to the head of the stringed musical instrument. A stringed musical instrument as disclosed produces a broader and fuller array of musical tones than conventional stringed instruments.

### TECHNICAL FIELD

The present invention relates generally to stringed musical instruments and more specifically to improvements in the design of stringed musical instruments, particularly guitars.

### BACKGROUND

Stringed musical instruments have been in existence for thousands of years, with instruments such as the lyre dating to at least 900 BC. Indeed, early Biblical writings are replete with references to the harp, lute, and lyre. The guitar is a member of the lute family of instruments and are believed to have originated in Europe in the 1400s. Today's modern guitar is believed to have originated in Spain in the mid-1800s by guitar maker Antonio de Torres Juarado. Modern guitars may be acoustic, where the body of the instrument amplifies the sound created by the vibration of the strings, or electric, where the vibration of the strings is converted to electrical signals and amplified by external means. Common parts of a guitar comprise a body which may be hollow or solid, a neck which includes a top surface called the fingerboard containing raised metal strips called frets, a headpiece located at the end of the neck containing a means for adjusting the tension of the strings called tuning keys, and a set of strings that can vary in number that are stretched from the body to the headpiece and are attached to the tuning keys.

The vibrations of the strings of an acoustic guitar resonate in the body, or sound box, which is generally hollow. The body is typically made of hardwoods of various types. Different woods may be used for the sides and back than are used for the top of the body. Each type of wood lends a different tone to the sounds produced. The neck is usually made of a structurally strong wood in order to withstand the forces exerted on it by the tensioned strings without warping. Strings are generally either nylon or steel, and the choice of string material is often related to the type of music being played.

Early electric guitars were simply acoustic guitars fitted with electrical pickups, a device similar to a microphone in that it converts string vibrations into electric signals that are reproduced as sound through an amplifier and speaker. These instruments eventually evolved into solid-body instruments in order to solve problems related to vibrations and undesirable noise. The first solid-body guitars were developed in the United States in the 1930's, with the earliest examples being Hawaiian, or slide, guitars. Most electric guitars today follow either the Les Paul design created for the Gibson Guitar Company, or the Stratocaster design of Leo Fender.

The playing of the guitar involves strumming or plucking the strings with the fingers of one hand or a plectrum, commonly known as a pick. Different musical notes or chords are created by pressing down on the strings at the frets with the fingers of the other hand, effectively shortening the vibrating length of the string. The playing of a slide guitar involves pressing down on the strings with a cylindrical object called a slide, rather than the musician's fingers. As with all stringed musical instruments, the playing of a conventional guitar involves the use of only a portion of each string. The portion of the string above the point of contact, whether contact is made by the musicians fingers or a slide, is effectively “shut off” from producing musical tones.

### SUMMARY

The playing of a guitar involves pressing down on one or more strings at one or more of the frets along the fingerboard to effectively shorten the string. The string is then plucked or strummed to induce vibration in the string. By pressing the string down onto one of the frets, the portion of the string above the pressure point is effectively “shut off” and produces no appreciable amount of sound. The present invention allows the portion of the string on both sides of the pressure point to be played, thus creating a richer and fuller array of musical tones that cannot be achieved with conventional stringed instruments.

One embodiment of the present invention has an elongated body with a generally flat top surface. Mounted on the top surface of the body are two fingerboards, each of which has its own set of frets. The two fingerboards are mounted end to end so that they form a generally continuous fingerboard and are collinear with one another. A number of strings are suspended parallel to one another over the fingerboards and are under tension. One end of the strings are secured to the body and the other end is attached to a mechanism that allows the tension of the strings to be adjusted. One fingerboard extends toward the secured end of the strings, and the other fingerboard extends toward the tension adjusting end of the strings. Thus, the fingerboards run parallel to the strings. The fret spacing of each fingerboard begins at the end where the two fingerboards meet. Thus, the fret spacing decreases on one of the fingerboards in the direction of the secured end of the strings, and decreases on the other fingerboard in the direction of the tension adjusting end of the strings. One or more electrical pickups are mounted at the secured end of the strings and one or more electrical pickups are mounted at the tension adjusting end of the strings.

The frets are attached to the top surface of the fingerboard and are oriented essentially perpendicular to the fingerboard and the strings. The frets extend above the top surface of the fingerboard. In another embodiment of the present invention, the frets are replaced by tone indicating markings on the surface of the fingerboard. These markings are flush with the top surface of the fingerboard, creating an essentially smooth surface along the entire length of the fingerboard.

In yet another embodiment of the present invention, the body of the musical instrument is hollow. The hollow body contains a first hole in the top surface located under the strings between the end of one of the fingerboards and the secured end of the strings. A second hole is located in the top surface of the body, also under the strings but between the end of the other fingerboard and the tension adjusting end of the strings. One embodiment of the hollow body musical instrument includes fretted fingerboards as described previously. In still another embodiment of the hollow body musical instrument, the fingerboards include tone indicating markings as described previously.

### BRIEF DESCRIPTION OF THE DRAWINGS

These and other features, aspects, and advantages of the present invention will become better understood with regard to the following description, appended claims, and accompanying drawings where:

FIG. 1 is an isometric view of an electric guitar embodiment of the present invention showing the location of the pickups and orientation of the fingerboards.

FIG. 2 is an isometric view of an acoustic guitar embodiment of the present invention showing the location of the holes in the hollow body of the guitar and the orientation of the fingerboards.

FIG. 3 is a diagramatic representation of the first five harmonic frequencies of a tensioned string such as found on a stringed musical instrument showing how the placement of electrical pickups affects the level of output sensed by the electrical pickups.

FIG. 4 is a diagramatic representation of a tensioned string of the present invention showing how multiple harmonic frequencies can be generated simultaneously on each string.

### DESCRIPTION

It is understood that the embodiments described herein are intended to serve as illustrative examples of certain embodiments of the present invention. Other arrangements, variations, and modifications of the described embodiments of the invention may be made by those skilled in the art. No unnecessary limitations are to be understood from this disclosure, and any such arrangements, variations, and modifications may be made without departing from the spirit of the invention and scope of the appended claims.

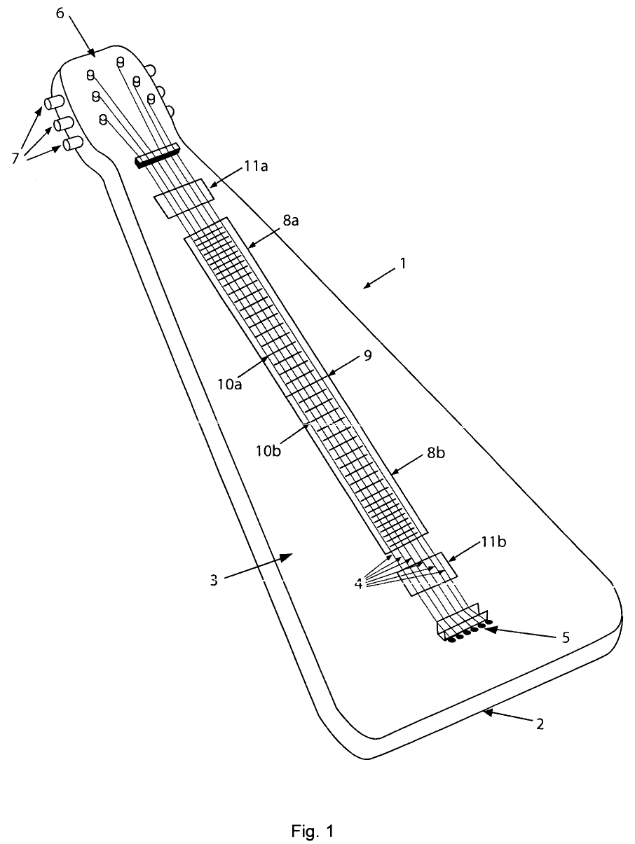

Referring in detail to the drawings, wherein like numerals represent like elements in multiple drawings, in FIG. 1, there is indicated generally at 1 an electric guitar embodiment of the present invention. The body 2 of the guitar is generally solid and may be constructed of any material or combination of materials suitable for a stringed musical instrument, such as wood, plastic, fiberglass, metal, or the like. The material of construction of the body is not critical to the present invention. Located on the top surface 3 of the body 2, are a plurality of strings 4. One embodiment of the present invention comprises six strings 4, although other embodiments may comprise a different number of strings 4. One end of the strings 4 are releasably secured to the top surface 3 by attachment means 5. The attachment means 5 may be any suitable device known to one skilled in the art, and is commonly referred to as the saddle and bridge. The end of the strings 4 releasably secured to the attachment means 5 is hereafter referred to as the “secured end” of the strings 4. The strings 4 extend distally from the secured end to the headpiece, indicated generally at 6. Provided on the headpiece 6 are tensioning members 7, to which the strings 4 are releasably secured. Thus, the strings 4 are maintained in a tensioned state as they are suspended above the top surface 3. In one embodiment of the present invention, there is one tensioning member 7 for each string 4, although other embodiments may employ other tensioning means. The end of the strings releasably secured to the tensioning members 7 is hereafter referred to as the “tension adjusting end” of the strings 4. With the exception of the secured end and the tension adjusting end, the strings 4 are suspended above the top surface 3. Located on the top surface 3 are fingerboards 8a and 8b. The fingerboards 8a and 8b are located generally collinear to one another. Fingerboards 8a and 8b are located parallel to and underneath the strings 4 such that there is a separation between the fingerboards 8a and 8b and the strings 4. Each fingerboard includes a distal end and a proximal end. The fingerboards 8a and 8b are oriented such that they are adjoined, indicated by 9 in FIG. 1. The ends of fingerboards 8a and 8b that are adjoined at 9 are referred to as the proximal ends. Thus, the distal end of fingerboard 8a extends toward the tension adjusting end of the strings 4, and the distal end of fingerboard 8b extends toward the secured end of the strings 4. In another embodiment of the present invention, there is a gap between the proximal ends of fingerboards 8a and 8b. Upon the surface of fingerboard 8a and 8b are a series of frets 10a and 10b generally oriented perpendicular to the direction of the strings 4. The frets 10a and 10b are conventional in design and project above the top surface of the fingerboards 8a and 8b. In another embodiment of the present invention, the frets are replaced by markings (not shown) on the top surfaces of the fingerboards such that the top surfaces of the fingerboards are essentially smooth along the entire length of the fingerboards. As is conventional with the frets of a stringed instrument, the spacing between the frets progressively decreases along the length of the fingerboard, indicating semitone intervals between frets. In the present invention, the spacing of the frets 10a and 10b is greatest at the proximal ends of fingerboards 8a and 8b, and progressively decreases toward the distal ends of fingerboards 8a and 8b. Located on the top surface 3 approximately just beyond the distal end of fingerboard 8a and underneath strings 4, are one or more electrical pickups 11a. Similarly, one or more electrical pickups 11b are located approximately just beyond the distal end of fingerboard 8b and underneath strings 4. Electrical pickups 11a and 11b convert the vibrations of strings 4 into electric signals which are transmitted to an amplification device (not shown).

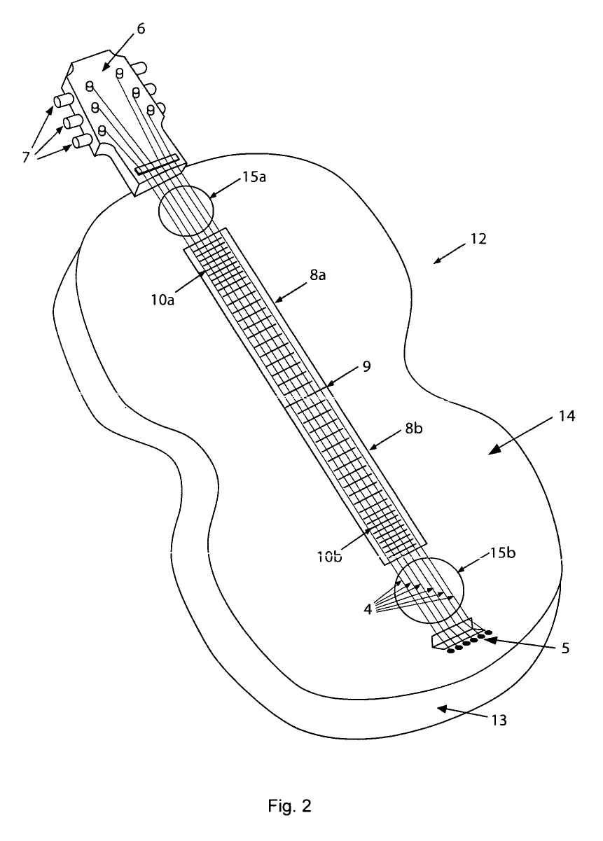

In FIG. 2, there is indicated generally at 12 an acoustic guitar embodiment of the present invention. The body 13 of the guitar is generally hollow and may be constructed of any material or combination of materials suitable for a stringed musical instrument, such as wood, plastic, fiberglass, metal, and the like. The top surface 14 of the body 13 is known as the sounding board. Located on the top surface 14 are a plurality of strings 4. One embodiment of the present invention comprises six strings 4, although other embodiments may comprise a different number of strings 4. One end of the strings 4 are releasably secured to the top surface 14 by attachment means 5. The attachment means 5 may be any suitable device known to one skilled in the art, and is commonly referred to as the saddle and bridge. The end of the strings 4 releasable secured to the attachment means 5 is hereafter referred to as the “secured end” of the strings 4. The strings 4 extend distally from the secured end to the headpiece, indicated generally at 6. Provided on the headpiece 6 are tensioning members 7, to which the strings 4 are releasable secured. Thus, the strings 4 are maintained in a tensioned state as they are suspended above the top surface 14. In one embodiment of the present invention, there is one tensioning member for each string 4, although other embodiments may employ other tensioning means. The end of the strings releasably secured to the tensioning members 7 is hereafter referred to as the “tension adjusting end” of the strings 4. With the exception of the secured end and the tension adjusting end, the strings 4 are suspended above the top surface 14. Located on the top surface 14 are fingerboards 8a and 8b. The fingerboards 8a and 8b are located generally collinear to one another. Fingerboards 8a and 8b are located parallel to and underneath the strings 4 such that there is a separation between the fingerboards 8a and 8b and the strings 4. Each fingerboard includes a distal end and a proximal end. The fingerboards 8a and 8b are oriented such that they are adjoined, indicated by 9 in FIG. 2. The ends of fingerboards 8a and 8b that are adjoined at 9 are referred to as the proximal ends. Thus, the distal end of fingerboard 8a extends toward the tension adjusting end of strings 4, and the distal end of fingerboard 8b extends toward the secured end of the strings 4. In another embodiment of the present invention, there is a gap between the proximal ends of fingerboards 8a and 8b. Upon the top surface of fingerboards 8a and 8b are a series of frets 10a and 10b generally oriented perpendicular to the direction of the strings 4. The frets 10a and 10b are conventional in design and project above the top surface of the fingerboards 8a and 8b. In another embodiment of the present invention, the frets are replaced by markings (not shown) on the top surfaces of the fingerboards such that the top surfaces of the fingerboards are essentially smooth along the entire length of the fingerboards. As is conventional with the frets of a stringed instrument, the spacing between the frets progressively decreases along the length of the fingerboard, indicating semitone intervals between frets. In the present invention, the spacing of the frets 10a and 10b is greatest at the proximal ends of fingerboards 8a and 8b, and progressively decreases toward the distal ends of fingerboards 8a and 8b. Located on the top surface 14 approximately just beyond the distal end of fingerboard 8a and underneath strings 4, is an opening 15a in the top surface extending into the hollow space within the body 13. Similarly, opening 15b is located approximately just beyond the distal end of fingerboard 8b and underneath strings 4. Opening 15b extends into the hollow space within the body 13. Openings 15a and 15b serve to project the sound created by the vibrating strings 4 and amplified by the body 13.

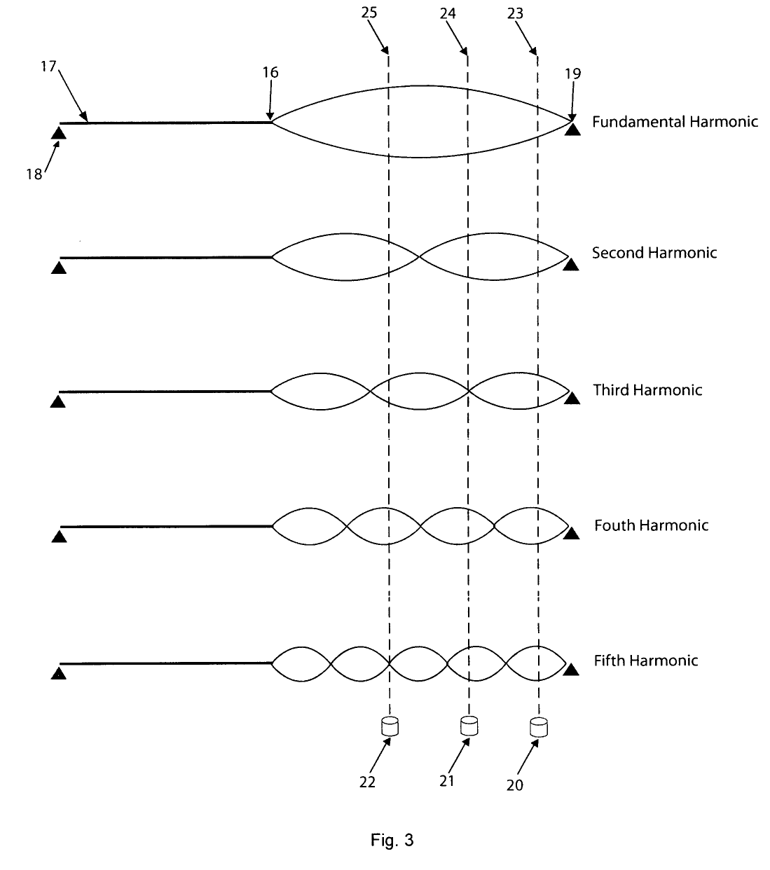

The frequency of vibration for the first five harmonics of a tensioned string are shown in FIG. 3. For a stringed musical instrument such as a guitar shown in FIG. 1 and FIG. 2, the secured end of the string 17 is indicated by 19 and the tension adjusting end of the string is indicated by 18. Additionally, the point where pressure is applied to the string 17 at any given fret is indicated by 16. In a conventional stringed instrument, only the portion of the string 17 between 16 and 19 is used to generate musical tones. The electrical pickups 20, 21, 22 of an electric guitar will sense a different level of output depending on where under the vibrating string 17 the electrical pickup 20, 21, 22 is placed. The level of output is proportional to the displacement of the string 17. Lines 23, 24, and 25 indicate the corresponding displacement of the string 17 for the position of electrical pickups 20, 21, and 22, respectively. For the fundamental harmonic in FIG. 3, pickup 20 senses a lower output from the string 17 than does electrical pickup 21, which in turn senses a lower output than electrical pickup 22. These effects become even more evident at the higher harmonics. Electrical pickup 21 is directly under a vibrational node when the string 17 is vibrating at the third harmonic and will have minimal output because there is little or no displacement of the string 17 at the node. However, this same electrical pickup 21 is located near the antinode of the string 17 when it is vibrating at the fourth harmonic and will sense near maximum displacement of the string 17 at this point.

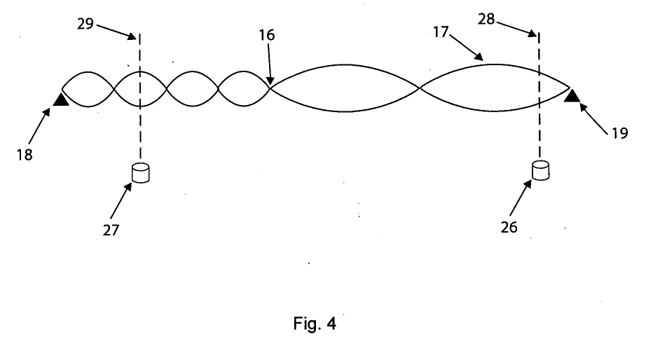

The unique ability of the present invention to produce a wide array of musical notes and tones is shown in FIG. 4. Similar to FIG. 3, pressure is applied to the string 17 at the point indicated by 16 which corresponds to the position of a fret. Now, the portion of the string 17 between 16 and 19 as well as the portion of the string 17 between 16 and 18 are utilized for producing musical tones. Electrical pickup 26 will sense a strong displacement of string 17 vibrating at the second harmonic as indicated by line 28. At the same time, electrical pickup 27 will sense a strong fourth harmonic displacement from the string 17 as indicated by line 29. This same dual-harmonic effect can be created in each of the strings either one string at a time or multiple strings together. The present invention, therefore, has the unique ability to produce a wider and richer range of musical tones than a conventional stringed musical instrument.

FIG. 3 and FIG. 4 illustrate the concept of the harmonic frequencies of the strings in relationship to an electric guitar employing electrical pickups. It is obvious to one skilled in the art that the present invention also encompasses any type of pickup, whether it is electrical, optical, electrostatic, or another type. It is also obvious to one skilled in the art that the concepts shown in FIG. 3 and FIG. 4 transfer equally to an acoustic guitar of the type shown in FIG. 2. Electrical pickups are shown in FIG. 3 and FIG. 4 for ease of illustration are not meant to be limiting in any manner.

One embodiment of the present invention comprises a fingerboard with frets. This embodiment is played in part like a conventional guitar where one or more fingers of one of the musician's hands press down one or more of the strings at the appropriate frets such that when the strings are plucked or strummed a certain note or chord is played. A unique aspect of the present invention is that the strings can be plucked or strummed on either side of the point where the strings are pressed down, enabling an expanded array of musical tones to be created.

Another embodiment of the present invention comprises a fingerboard with markings on the top surface rather than frets such that the top surface of the fingerboard is smooth. This embodiment facilitates the playing of the instrument in the manner of a slide guitar, also known as a Hawaiian guitar. The slide, typically a metal cylindrical object, is placed across the strings and is used to press down the strings while strumming or plucking to form musical tones. As the slide is moved up or down the strings, the changing length of the vibrating portion of the strings changes the frequency of vibration. If the slide is moved in one direction, the length of the vibrating portion of the strings is shortened, resulting in an increasing pitch of the sound produced. Alternately, moving the slide in the opposite direction increases the length of the vibrating portion of the strings, causing the pitch to decrease. In the present invention, the strings can be plucked or strummed on both sides of the slide. Thus, by moving the slide in one direction, the musician can simultaneously create sounds of both increasing and decreasing pitch. The array of musical tones that can be produced with the present invention is unique among stringed musical instruments.

The wide array of musical tones produced by the present invention can be portrayed mathematically. When a string of the present invention is pressed down, two segments of string are effectively created, each shorter in length than the original string. If we let the variable “n” equal the ratio of the length of one of the segments to the length of the original string, the frequency of vibration of this shortened segment of string (relative to the fundamental frequency of the original string) is represented by 1/n. Similarly, the ratio of the length of the second shortened segment of string to the length of the original string is represented by 1−n, and the frequency of vibration of the second segment of string (relative to the fundamental frequency of the original string) is represented by 1/(1−n). This frequency ratio defines musical (frequency) intervals. For example, the perfect fourth inverval occurs when 1/n=4/3, and the perfect fifth interval occurs when 1/n=3/2.

Thus, the frequency interval of the first segment of the shortened string to the second segment of the shortened string is represented by n/(1−n). In other words, n/(1−n) is the frequency interval between the first and second segments of the string when the segments are played simultaneously. Since the relationship of the string segments is symmetrical, (1−n)/n represent the same interval only going down the scale rather than up the scale.

The ability of the present invention to produce unique musical tones can begin to be seen when the ratio of the length of the first string segment to the second string segment is an integer. When the ratio is 2 (that is, the length of the first string segment is twice that of the second string segment), n is 1/3 and 1−n is 2/3. When n is 1/3, the frequency of vibration is an octave and a perfect fifth interval above the harmonic frequency and when n is 2/3, the frequency of vibration is a perfect fifth interval above the harmonic frequency. This octave separation between the frequency of vibration of these two segments imparts a harmonious sound when played together. When the ratio is 3 (that is, the length of the first string segment is three times that of the second string segment, n is 1/4 and 1−n is 3/4. The frequency of vibration of these two string segments will be separated by an octave and a perfect fifth interval, again producing a harmonious combination. A 4/3 perfect fourth interval can be created by the two string segments when n is 3/7 and 1−n is 4/7 (that is, (1−n)/n=(4/7)/(3/7)=4/3).

However, when the ratio of (1−n)/n is a rational number instead of an integer, notes are created that diverge from the intervals of the traditional music scale. Table 1 shows the ratios of the first 19 half steps in a 12-note scale, which is approximated by a logarithmic scale such that the ratio of the frequency of any note that is “x” half steps above the fundamental frequency to the fundamental frequency is given by the equation 2^{(x/12)}. Hence, whenever x is a multiple of 12, the note rises an octave (the frequency doubles). As shown previously, the interval between the frequencies of the two string segments is a perfect fourth when n is 3/7 and 1−n is 4/7. The “note” of each of these segments relative to the fundamental frequency of the string is 7/3 (2.33333) and 7/4 (1.75000), respectively. These notes fall between the half steps 14 and 15 of the table for 7/3 and between half steps 9 and 10 for 7/4. While such semitones may sounds discordant when played on other musical instruments, they have a pleasant, harmonious sound when played on the present invention.

TABLE 1

| Half Step from the | Ratio of the Frequency of Two |
|---|---|
| Fundamental (x) | String Segments |
| 0 | 1.00000 (fundamental frequency) |
| 1 | 1.05946 |
| 2 | 1.12246 |
| 3 | 1.18921 |
| 4 | 1.25992 |
| 5 | 1.33484 (approximate perfect fourth above |
| | fundamental - 4/3 = 1.33333) |
| 6 | 1.41421 |
| 7 | 1.49831 (approximate perfect fifth above |
| | fundamental - 3/2 = 1.50000 |
| 8 | 1.58740 |
| 9 | 1.68179 |
| 10 | 1.78180 |
| 11 | 1.88775 |
| 12 | 2.00000 (one octave above fundamental) |
| 13 | 2.11893 |
| 14 | 2.24492 |
| 15 | 2.37841 |
| 16 | 2.51984 |
| 17 | 2.66968 (approximate octave and a perfect fourth |
| | above fundamental - 2*4/3 = 2.66666) |
| 18 | 2.82843 |
| 19 | 2.99661 (approximate octave and a perfect fifth |
| | above fundamental - 2*3/2 = 3.00000) |

I claim:

1. A stringed musical instrument comprising:
a. an elongated body portion with a generally flat top surface;
b. a first fingerboard on the top surface of the body portion, having a distal end, a proximal end, and a top surface;
c. a second fingerboard on the top surface of the body portion, having a distal end, a proximal end, and a top surface, the second fingerboard oriented collinear with the first fingerboard;
d. a plurality of tensioned strings extending essentially parallel to one another above and parallel with the first fingerboard and the second fingerboard;
e. means for securing the strings at one end of the body portion and means for adjusting the tension of the strings at the other end of the body portion;
f. at least one electrical pickup means for the strings located at the secured end of the strings; and
g. at least one electrical pickup means for the strings located at the tension adjusting end of the strings.

2. The stringed musical instrument of claim 1 wherein the distal end of the first fingerboard is oriented toward the secured end of the strings.

3. The stringed musical instrument of claim 1 wherein the distal end of the second fingerboard is oriented toward the tension adjusting end of the strings.

4. The stringed musical instrument of claim 1 wherein the proximal end of the first fingerboard is adjoined to the proximal end of the second fingerboard, creating a generally continuous fingerboard.

5. The stringed musical instrument of claim 1 wherein the first and second fingerboards contain a plurality of frets attached to the top surface of each fingerboard, the frets being oriented essentially perpendicular to the fingerboards and extending above the top surface of each fingerboard.

6. The stringed musical instrument of claim 5 wherein the fret spacing of the first fingerboard begins at the proximal end and continues toward the distal end such that the fret spacing decreases toward the distal end.

7. The stringed musical instrument of claim 5 wherein the fret spacing of the second fingerboard begins at the proximal end and continues toward the distal end such that the fret spacing decreases toward the distal end.

8. The stringed musical instrument of claim 4 wherein the first and second fingerboards contain a plurality of tone indicating markings on the top surface of each fingerboard, the tone indicating markings being oriented essentially perpendicular to the fingerboards and flush with the top surface of the fingerboards such that the top surface of each fingerboard is essentially smooth along the entire length of each fingerboard.

9. The stringed musical instrument of claim 8 wherein the spacing of the tone indicating markings of the first fingerboard begins at the proximal end and continues toward the distal end such that the spacing between the tone indicating markings decreases toward the distal end.

10. The stringed musical instrument of claim 8 wherein the spacing of the tone indicating markings of the second fingerboard begins at the proximal end and continues toward the distal end such that the spacing between the tone indicating markings decreases toward the distal end.

11. A stringed musical instrument comprising:
a. an elongated hollow body portion with a generally flat top surface;
b. a first fingerboard on the top surface of the body portion, having a distal end, a proximal end, and a top surface;
c. a second fingerboard on the top surface of the body portion, having a distal end, a proximal end, and a top surface, the second fingerboard oriented collinear with the first fingerboard;
d. a plurality of tensioned strings extending essentially parallel to one another above and parallel to the first fingerboard and the second fingerboard;
e. means for securing the strings at one end of the body portion and means for adjusting the tension of the strings at the other end of the body portion;

12. The stringed musical instrument of claim 11 wherein the distal end of the first fingerboard is oriented toward the secured end of the strings.

13. The stringed musical instrument of claim 11 wherein the distal end of the second fingerboard is oriented toward the tension adjusting end of the strings.

14. The stringed musical instrument of claim 11 wherein the proximal end of the first fingerboard is adjoined to the proximal end of the second fingerboard creating a generally continuous fingerboard.

15. The stringed musical instrument of claim 11 wherein the first and second fingerboards contain a plurality of frets attached to the top surface of each fingerboard, the frets being oriented essentially perpendicular to the fingerboards and extending above the top surface of each fingerboard.

16. The stringed musical instrument of claim 15 wherein the fret spacing of the first fingerboard begins at the proximal end and continues toward the distal end such that the fret spacing decreases toward the distal end.

17. The string musical instrument of claim 15 wherein the fret spacing of the second fingerboard begins at the proximal end and continues toward the distal end such that the fret spacing decreases toward the distal end.

18. The stringed musical instrument of claim 14 wherein the first and second fingerboards contain a plurality of tone indicating markings on the top surface of each fingerboard, the tone indicating markings being oriented essentially perpendicular to the fingerboards and flush with the top surface of the fingerboards such that the top surface of each fingerboard is essentially smooth along the entire length of each fingerboard.

19. The stringed musical instrument of claim 18 wherein the spacing of the tone indicating markings of the first fingerboard begins at the proximal end and continues toward the distal end such that the spacing between the tone indicating markings decreases toward the distal end.

20. The stringed musical instrument of claim 18 wherein the spacing of the tone indicating markings of the second fingerboard begins at the proximal end and continues toward the distal end such that the spacing between the tone indicating markings decreases toward the distal end.

21. The stringed musical instrument of claim 11 wherein the elongated hollow body portion contains an essentially circular hole in the top surface located under the strings between the distal end of the first fingerboard and the secured end of the strings.

22. The stringed musical instrument of claim 11 wherein the elongated hollow body portion contains an essentially circular hole in the top surface located under the strings between the distal end of the second fingerboard and the tension adjusting end of the strings.
